(19) United States
(12) Patent Application Publication
(10) Pub. No.: US 2014/0278975 A1
(43) Pub. Date: Sep. 18, 2014

(54) METHOD AND SYSTEM FOR INTERACTIVE SELECTION AND DISPLAY OF DIGITAL CONTENTS

(71) Applicant: QNAP SYSTEMS, INC., New Taipei City (TW)

(72) Inventors: Yau-Tsung Lee, New Taipei City (TW); Chia-Liang Wei, New Taipei City (TW); Zheng-Wei Ko, New Taipei City (TW); Tsai-Su Lo, New Taipei City (TW)

(73) Assignee: QNAP SYSTEMS, INC., New Taipei City (TW)

(21) Appl. No.: 14/155,384

(22) Filed: Jan. 15, 2014

Related U.S. Application Data
(60) Provisional application No. 61/798,959, filed on Mar. 15, 2013.

(51) Int. Cl. G06Q 30/02

(52) U.S. Cl. CPC G06Q 30/0255
USPC 705/14.53

(57) ABSTRACT

A system for interactive selection and display of digital contents at a viewer's interest includes a server, at least one digital signage device and at least one terminal device. The at least one digital signage device includes a player in communication with the server and a display device in communication with the player. The at least one terminal device is in communication with the at least one player. The terminal device is configured to acquire a playlist of digital contents from the player, automatically generate a structured menu of selection from the playlist, select a digital content of interest from the structured menu of selection, and instruct the player to play the selected digital content. The player plays the selected digital content accordingly.

### CROSS REFERENCE TO RELATED APPLICATIONS

This application claims the benefits of U.S. Provisional Application No. 61/798,959, filed on Mar. 15, 2013 and entitled “METHOD AND SYSTEM FOR INTERACTIVE SELECTION AND DISPLAY OF DIGITAL CONTENTS”, the contents of which are incorporated herein by reference.

### BACKGROUND OF THE INVENTION

1. Field of the Invention

The present invention relates to a system for interactive selection and display of digital contents and related method, and more particularly, to a system for interactive selection and display of digital contents at a viewer's interest and related method.

2. Description of the Prior Art

Conventionally, most of advertising signage or display systems are adapted to display fixedly one or more advertisements (ads) or dynamically a number of ads in an order in accordance with a playlist schedule. As such, it cannot selectively display one or more ads that have been displayed, but a viewer is interested in. To watch the one or more ads again, the viewer will have to wait until the one or more ads are displayed in the next round. In addition, if the playlist schedule has expired, the viewer will no longer be able to watch the ads any more.

Therefore, a heretofore unaddressed need exists in the art to address the aforementioned deficiencies and inadequacies.

### SUMMARY OF THE INVENTION

Therefore, the primary objective of the invention is to provide a system for interactive selection and display of digital contents at a viewer's interest and related method.

In one aspect, the present invention relates to a system for interactive selection and display of digital contents at the viewer's interest. In one embodiment, the system has a server, at least one digital signage device, wherein the at least one digital signage device comprises a player in communication with the server, and a display device in communication with the player; and at least one terminal device, wherein the at least one terminal device is in communication with the at least one player. The terminal device is configured to acquire a playlist of digital contents from the player; automatically generate a structured menu of selection from the playlist; select a digital content of interest from the structured menu of selection; instruct the player to play the selected digital content, and wherein the player plays the selected digital content accordingly.

In one embodiment, the server is configured to design the digital contents and its playlist, and publish/export the digital contents.

In one embodiment, the player is configured to acquire or receive the digital contents and its playlist, and play the digital contents according to the playlist.

In another aspect, the present invention relates to a method for interactive selection and display of digital contents at the viewer's interest. In one embodiment, the method includes the steps of designing digital contents, and publishing/exporting the digital contents, by a server; acquiring/importing the digital contents by the player; obtaining digital content information from the player, and generating a structured menu of selection by the terminal device; selecting one item of the digital contents from the terminal device by a user; requesting the player to play the selected interaction contents by the terminal device; and playing the selected content on the display device by the player.

The method may further include, if the number of requests, from the terminal device to the player, to play a specific digital content during a period of time is greater than a predetermined number, and all the interrupted play orders are the same, the player instructs the server to change the playlist accordingly.

Yet another aspect of the present invention provides a computer-readable medium storing instructions which, when executed by one or more processors, cause the above-disclosed system to perform the above-disclosed method.

These and other aspects of the present invention will become apparent from the following description of the preferred embodiment taken in conjunction with the following drawings, although variations and modifications therein may be effected without departing from the spirit and scope of the novel concepts of the invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 shows schematically a system for interactive selection and display of digital contents according to one embodiment of the invention.

FIG. 2 shows schematically a flowchart of a method for interactive selection and display of digital contents according to one embodiment of the invention.

FIG. 3 shows schematically modified playlists of digital contents according to one embodiment of the invention.

FIG. 4 shows schematically modified playlists of digital contents according to one embodiment of the invention.

### DETAILED DESCRIPTION

In one aspect, the present invention relates to a system for interactive selection and display of digital contents, such as ads, at the viewer's interest. The digital contents can be any types of digital contents such as ads, documentations, pictures, music, videos, texts, or the likes. In one embodiment, the system includes a server, at least one digital signage device and at least one terminal device, as shown in FIG. 1. Each digital signage device includes a player in communication with the server and a display device in communication with the player. Additionally, at least one terminal device is in communication with the at least one player. In one embodiment, the player is configured to acquire or receive the digital contents and its playlist and play the digital contents according to the playlist. The terminal device is configured to acquire the playlist from the player; automatically generate a structured menu of selection from the playlist; select a digital content of interest from the structured menu of selection; instruct the player to play the selected digital content. The player plays the selected digital content accordingly.

The terminal device can be a mobile phone, a tablet, a laptop, a PDA, a remote controller, or the like.

The server, for example, iSignager, stores the information of the digital contents, such as a playlist of the digital contents for the at least one player, and by a normal setting, instructs the player to play the digital contents in the order in accordance with the playlist. The played digital contents are displayed in the order of the playlist on the display device, such as a television, a display broad, or the like. For example, assuming there are four digital contents, A, B, C and D that are arranged in the order of A->B->C->D in the playlist, the digital contents A, B, C and D will be displayed in the order of A->B->C->D on the display device by the normal setting.

According to the invention in FIG. 3, a user, through the terminal device, can change or modify the player order of the digital contents by interactively selecting one or more of the digital contents that he/she desires to play. For example, if the user is interested in the digital content B, he/she can use the terminal device to send an instruction to the player to stop playing what it is playing and start to play the digital content B he/she selects. Accordingly, the play order of the digital contents could be ABCBABCD, ABBABCD, ABCDBABCD, ABBCD, ABCBD, or ABCDB, depending upon when the instruction is initiated. For example, if the player has just played out the digital content C when the user instructs the player to play the digital content B, the player will immediately play the digital content B, instead of the digital content D. The digital content D will be displayed after the display of the inserted digital content B. Accordingly, the order of the digital contents will be in the order of ABCBD. After this interruption, the player will play the digital contents in the scheduled order of ABCBD again, if no further instruction from the terminal device by the user is initiated during the playing. In addition, the user, through the terminal device, is also able to instruct the player not to play a specific digital content, i.e., C. In this case, the play order of the digital contents will be of ABD.

According to another embodiment of the invention in FIG. 4, a user, through the terminal device, can change or modify the player order of the digital contents by interactively selecting one or more of the digital contents that he/she desires to play. For example, if the user is interested in the digital contents B and A, he/she can use the terminal device to send an instruction to the player to stop playing what it is playing and start to play the digital contents B and A he/she selects. Accordingly, the play order of the digital contents could be ABBAABCD, ABCBAABCD, ABCDBAABCD, ABBACD, ABCBAD, or ABCDBA, depending upon when the instruction is initiated.

Furthermore, according to the invention in FIG. 3, the system is configured such that, if the number of requests, from the terminal device to the player, to play a specific digital content during a period of time is greater than a predetermined number, for example, greater than 20 times over the last 24 hours, and all the interrupted play orders are the same as well, the player will instruct the server to change the playlist accordingly. As a result, the player in turn, will play the digital contents in the order in accordance with the changed playlist in the next playing rounds.

Moreover, according to the invention, the least one player can have any number of players, and the at least one terminal device can have any number of terminal devices. Each player plays respective digital contents in accordance with a respective playlist. The respective playlist can be changed or modified by a user through a respective terminal device, as discussed above.

In another aspect of the present invention, a method for interactive selection and display of digital contents at the viewer's interest includes that a player acquires a playlist of digital contents from an iSignager on a server and plays the digital contents in the order according to the playlist; a user through a terminal device, selects a digital content of interest and instructs the player to play the selected digital content immediately; the player plays the selected digital content accordingly; and after playing the selected digital content, the player plays the rest of the digital contents in accordance with the playlist.

In one embodiment, if the number of requests, from the terminal device to the player, to play the specific digital content during a period of time is greater than a predetermined number and all the interrupted play orders are the same, the method also includes that the player instructs the server to change the playlist accordingly. As a result, the player in turn, plays the digital contents in the order in accordance with the changed playlist in the next playing rounds.

In one embodiment, the method for interactive selection and display of digital contents at the viewer's interest includes the following steps, as shown in FIG. 2. At first, the iSignager on the server designs interaction (digital) contents, and then publishes/exports the interaction contents. The player imports the interaction contents. The terminal device obtains interaction content information from the player, and generates a structured menu of selection. A user selects one item of the interaction contents from the terminal device. The terminal device then requests the player to play the selected interaction contents. The player plays the user selected content on the display device.

All or part of the steps according to the embodiments of the present invention may be implemented by using software, and the corresponding software programs may be stored in a readable storage medium, such as a compact disk or a hard disk.

Yet another aspect of the present invention provides a non-transitory tangible computer-readable medium storing instructions which, when executed by one or more processor, cause the system to perform a method for interactive selection and display of digital contents at the viewer's interest, as disclosed above. The non-transitory tangible computer-readable storage medium includes, but not limited to, disk, CD-ROM, read-only memory (ROM), random memory (RAM), flash dive, or the likes.

Aspects of the present invention are further disclosed and described in Appendix A, which are incorporated herein by reference in its entireties as an integral part of the application.

The foregoing description of the exemplary embodiments of the invention has been presented only for the purposes of illustration and description and is not intended to be exhaustive or to limit the invention to the precise forms disclosed. Many modifications and variations are possible in light of the above teaching.

While there has been shown several and alternate embodiments of the present invention, it is to be understood that certain changes can be made as would be known to one skilled in the art without departing from the underlying scope of the invention as is discussed and set forth above and below including claims and drawings. Furthermore, the embodiments described above and claims set forth below are only intended to illustrate the principles of the present invention and are not intended to limit the scope of the invention to the disclosed elements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system for interactive selection and display of digital contents at a viewer's interest, comprising:
(a) a server;
(b) at least one digital signage device, wherein the at least one digital signage device comprises a player in communication with the server, and a display device in communication with the player; and
(c) at least one terminal device, wherein the at least one terminal device is in communication with the at least one player,
wherein the terminal device is configured to acquire a playlist of digital contents from the player; automatically generate a structured menu of selection from the playlist; select a digital content of interest from the structured menu of selection; instruct the player to play the selected digital content, and wherein the player plays the selected digital content accordingly.

2. The system of claim 1, wherein the server is configured to design the digital contents and its playlist, and publish/export the digital contents to the players.

3. The system of claim 1, wherein the player is configured to acquire or receive the digital contents and its playlist, and play the digital contents according to the playlist.

4. A method for interactive selection and display of digital contents at a viewer's interest, comprising:
(a) designing digital contents, and publishing/exporting the digital contents, by a server;
(b) acquiring/importing the digital contents by a player;
(c) obtaining digital content information from the player, and generating a structured menu of selection by a terminal device;
(d) selecting one item of the digital contents from the terminal device by a user;
(e) requesting the player to play the selected interaction contents by the terminal device; and
(f) playing the selected content on the display device by the player.

5. The method of claim 4, further comprising: if the number of requests, from the terminal device to the player, to play a specific digital content during a period of time is greater than a predetermined number, and all the requests of the digital contents playing orders are the same, the player instructs the server to change the playlist accordingly.

6. The method of claim 4, further comprising: if the number of requests, from the terminal device to the player, to play a specific digital content during a period of time is greater than a predetermined number, the player instructs the server to change the playlist accordingly to make the specific digital content for playing more times or playing earlier than an original playing order.

7. A computer-readable medium storing instructions which, when executed by one or more processors to perform the method of claim 4.
